(19) United States
(12) Patent Application Publication
(10) Pub. No.: US 2020/0330997 A1
(43) Pub. Date: Oct. 22, 2020

(54) THERMAL CYCLER DEVICE FOR IMPROVING HEAT TRANSFER UNIFORMITY AND THERMAL HISTORY CONSISTENCY

(71) Applicant: Quark Biosciences Taiwan, Inc., Hsinchu County (TW)

(72) Inventors: Cheng-Wey Wei, Hsinchu County (TW); Yung-Ching Lee, Miaoli County (TW)

(73) Assignee: Quark Biosciences Taiwan, Inc., Hsinchu County (TW)

(21) Appl. No.: 16/559,642

(22) Filed: Sep. 4, 2019

(30) Foreign Application Priority Data
Apr. 18, 2019 (TW) 108113530

(51) Int. Cl. B01L 7/00; B01L 9/00

(52) U.S. Cl. CPC B01L 7/52; B01L 2300/1894; B01L 2300/1811; B01L 9/52

(57) ABSTRACT

A thermal cycler device is provided, including an annular conveying element having a circular conveying path, a plurality of slide plate device holding elements, a plurality of heating blocks, a pressing element and a cooling device. The annular conveying element operates in stages, such that the slide plate device holding elements move along the circular conveying path while carrying a plurality of slide plate devices. When each slide plate device holding element moves to the corresponding heating block, the annular conveying element stops operating and the pressing element performs the pressing process, such that each slide plate device contacts the corresponding heating block for heat transfer.

### CROSS-REFERENCE TO RELATED APPLICATION

This application claims the priority benefit of Taiwan application serial no. 108113530, filed on Apr. 18, 2019. The entirety of the above-mentioned patent application is hereby incorporated by reference herein and made a part of this specification.

### BACKGROUND

### Technical Field

The present disclosure relates to a thermal cycler device, and more particularly, to a thermal cycler device that improves heat transfer uniformity and thermal history consistency.

### Description of Related Art

When performing the technique of molecular biology based on the polymerase chain reaction (PCR), a thermal cycler device can provide a programmed temperature profile to be carried out in reaction or test of sample(s) for the amplification reaction of the nucleic acid. As for the known thermal cycler device, the thermal cycling reaction can be performed by using a conveying element which conveys a slide plate device through more than one temperature zones. The slide plate device is used to accommodate a slide plate having thousands of reaction wells. The temperature of the slide plate device is controlled to ascend or descend through heating blocks in the temperature zones, thereby achieving the reaction temperature cycles required for the testing sample in the slide plate. However, if the heating blocks in the temperature zone fails to heat and cool in time and quickly, it may cause the problem of inconsistent thermal history, which may affect the experimental results.

Based on the above, it is as an important issue for current research to develop a thermal cycler device capable of improving heat transfer uniformity and thermal history consistency, making experimental results more stable, and enhancing operational convenience.

### SUMMARY

The disclosure provides a thermal cycler device, which is designed with a pressing element to fix the pressing force for heat transfer uniformity and to reinforce the stability of the experimental result, while improving the shortcomings of conventional thermal cycler device which uses thermal medium such as oil and causes operational inconvenience. Besides, a cooling device is used to cool the heating block quickly, so as to enhance the consistency of thermal history.

In the present disclosure, a thermal cycler device includes an annular conveying element, a plurality of slide plate device holding elements, a plurality of heating blocks, a pressing element and a cooling device. The annular conveying element has a closed circular conveying path. The plurality of slide plate device holding elements are disposed on the annular conveying element for holding a plurality of slide plate devices, and each of the slide plate device holding elements is arranged side by side along the circular conveying path at the same angle. The heating blocks are disposed under the annular conveying element. The pressing element is disposed above the plurality of slide plate device holding elements and having a plurality of pressing blocks, and each of the pressing blocks respectively corresponds to each heating block. The cooling device cools the plurality of heating blocks. The annular conveying element is operated in stages, such that the plurality of slide plate device holding elements carry a plurality of slide plate devices to move along the circular conveying path. When each of the slide plate device holding elements moves to the respective corresponding heating block, the annular conveying element is stopped, and each pressing block performs a pressing process such that each slide plate device comes into contact with the corresponding heating block for heat transfer.

In an embodiment of the disclosure, each of the slide plate device holding elements is arranged side by side along a circular conveying path at an angle of 60 degrees.

In an embodiment of the disclosure, the cooling device includes a water cooling device, and the water cooling device uses a waterway to enter the heating block to perform cooling.

In an embodiment of the disclosure, the water cooling device cools the heating block from 95° C. to 60° C. in 18 seconds.

In an embodiment of the disclosure, the cooling device further includes a fan device. When the water cooling device cools the heating block to a specific temperature, the temperature is maintained by the fan device and heating bars.

In an embodiment of the disclosure, after the heating block is cooled to 60° C., the temperature is maintained by the fan device and the heating bar.

In an embodiment of the disclosure, the thermal cycler device further includes a plurality of elastic supporting elements corresponding to each of the slide plate device holding elements. After each of the slide plate device and the corresponding heating block have performed the heat transfer for a specific period of time, the plurality of pressing blocks stop pressing, and each of the elastic supporting elements moves each of the slide plate device holding elements away from the heating block, thereby stopping the heat transfer between the slide plate device and the heating block. The annular conveying element resumes operation, such that each of the slide plate device holding elements moves along the circular conveying path to the next respective corresponding heating block.

In an embodiment of the disclosure, the annular conveying element stops operating at a specific fixed angle.

In an embodiment of the disclosure, the thermal cycler device further includes heating bars to heat the plurality of heating blocks.

In an embodiment of the disclosure, the heating bars heat the heating block to 95° C.

Based on the above, the present disclosure provides a thermal cycler device that is designed with the annular conveying element along with the pressing element to fix the pressing force, thereby achieving heat transfer uniformity and reinforcing stability of experiment results, while improving the shortcomings of conventional thermal cycler device which uses thermal medium such as oil and causes inconvenience. Additionally, the thermal cycler device in the present disclosure is provided with the water cooling device, such that the waterway of the water cooling device enters the heating block to cool the temperature quickly, and the heating block can be cooled from 95° C. to 60° C. in 18 seconds to enhance thermal history consistency. As a result, the adverse effects of the conventional thermal cycler device on the inability to efficiently and instantly regulate the temperature of the heating block can be improved.

In order to make the aforementioned features and advantages of the disclosure more comprehensible, embodiments accompanying figures are described in detail below.

### BRIEF DESCRIPTION OF THE DRAWINGS

FIG. 1 is a schematic view of a thermal cycler device according to an embodiment of the present disclosure.

FIG. 2 is a schematic exploded view of a thermal cycler device according to an embodiment of the present disclosure.

FIG. 3 and FIG. 4 are schematic cross-sectional views of a thermal cycler device according to an embodiment of the present disclosure.

FIG. 5A is a top view of a slide plate device holding element and a slide plate device of a thermal cycler device according to an embodiment of the present disclosure.

FIG. 5B is a schematic exploded view of a slide plate device holding element and a slide plate device of a thermal cycler device according to an embodiment of the disclosure.

FIG. 6 is a schematic view of a water cooling device in a thermal cycler device according to an embodiment of the present disclosure.

FIG. 7 is a top view of a water cooling device in a thermal cycler device according to an embodiment of the present disclosure.

FIG. 8 is a complete schematic view of a water cooling device in a thermal cycler device according to an embodiment of the present disclosure.

### DESCRIPTION OF THE EMBODIMENTS

The disclosure provides a thermal cycler device, which is mainly applied to molecular biotechnology based on the polymerase chain reaction (PCR). In the following paragraphs, the definitions of the terminologies used in the specification are first explained.

“Slide plate device” refers to a device for mounting a slide plate having thousands of experimental reaction vessels, and the size of the experimental reaction vessel ranges, for example, from several nanoliters to several hundred nanoliters, for placing testing samples for performing specific biochemical reactions or biochemical tests.

“Thermal history” refers to a reaction temperature cycle process which a slide plate device is subjected to, where a thermal cycler device performs heat transfer to the slide plate device through heating blocks in order to perform the polymerase chain reaction.

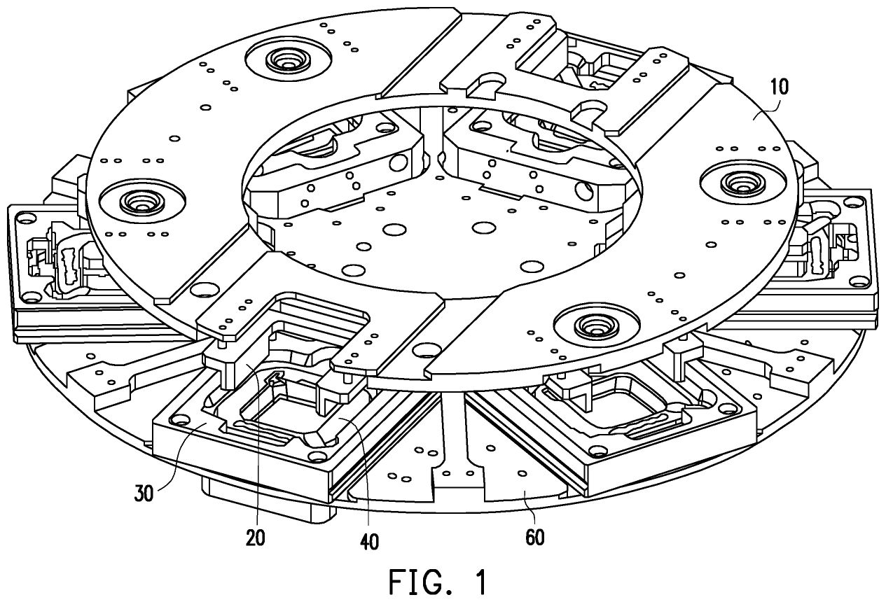

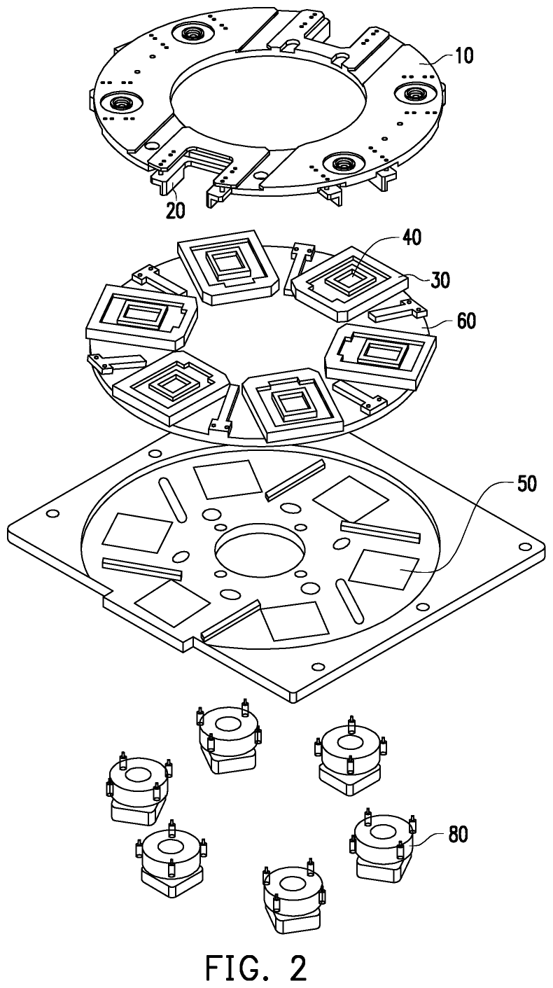

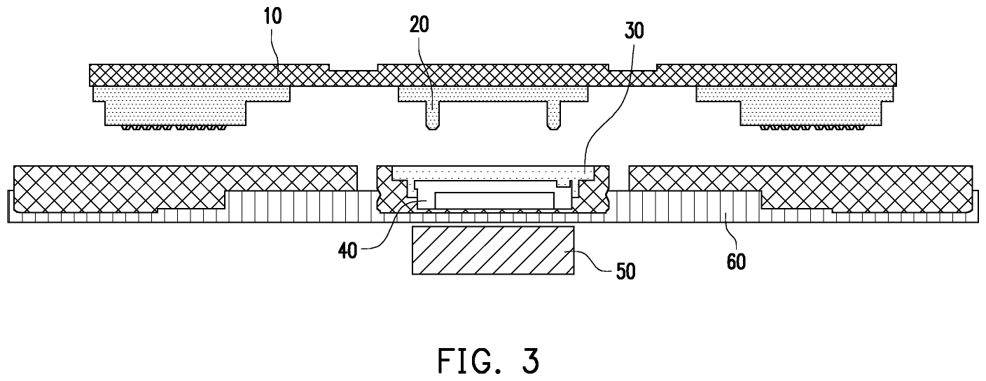

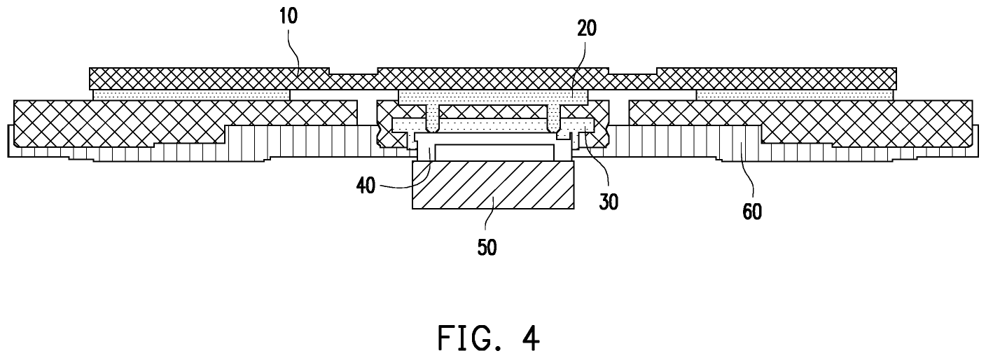

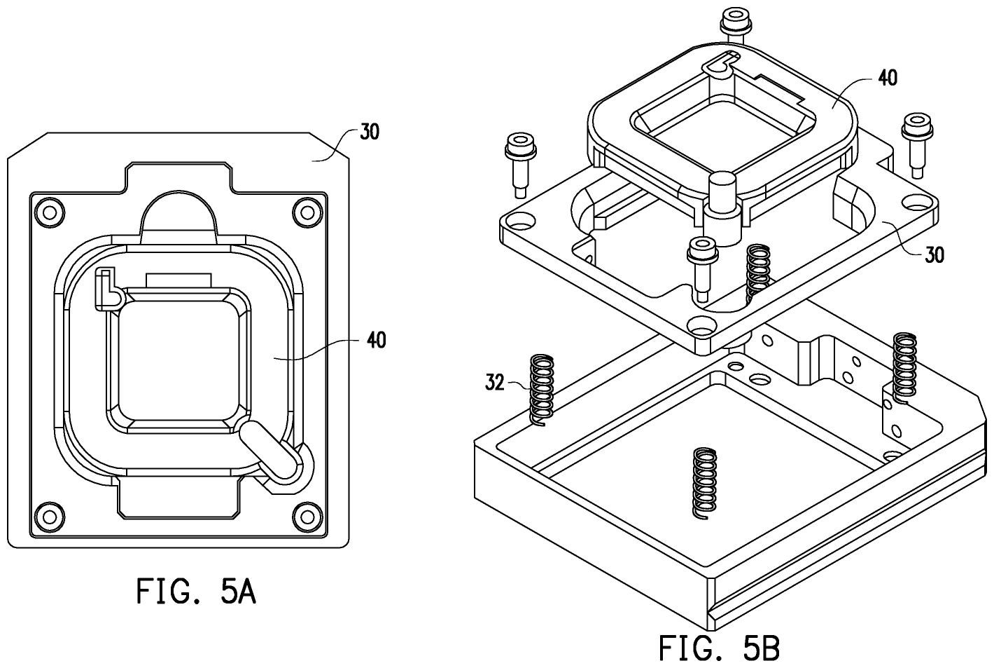

FIG. 1 is a schematic view of a thermal cycler device according to an embodiment of the present disclosure. FIG. 2 is a schematic exploded view of a thermal cycler device according to an embodiment of the present disclosure. FIG. 3 and FIG. 4 are schematic cross-sectional views of a thermal cycler device according to an embodiment of the present disclosure. FIG. 5A is a top view of a slide plate device holding element and a slide plate device of a thermal cycler device according to an embodiment of the present disclosure. FIG.

5B is a schematic exploded view of a slide plate device holding element and a slide plate device of a thermal cycler device according to an embodiment of the disclosure.

Referring to FIG. 1, FIG. 2, FIG. 3, FIG. 4, FIG. 5A and FIG. 5B, a thermal cycler device includes an annular conveying element 60, a plurality of slide plate device holding elements 30, a plurality of heating blocks 50, a pressing element 10, cooling devices (fan devices 80) for cooling the plurality of heating blocks 50, and a plurality of elastic supporting elements 32. As shown in FIG. 1, FIG. 2 and FIG. 3, the annular conveying element 60 has a closed circular conveying path. A plurality of slide plate device holding elements 30 are disposed on the annular conveying element 60 for holding a plurality of slide plate devices 40. Each of the slide plate device holding elements 30 is disposed side by side along a circular conveying path at the same angle, for example. The plurality of heating blocks 50 are disposed under the annular conveying element 60. The pressing element 10 is disposed above the plurality of slide plate device holding elements 30 and has a plurality of pressing blocks 20, and each of the pressing blocks 20 is disposed respectively corresponding to each of the heating blocks 50. As shown in FIG. 5B, a plurality of elastic supporting elements 32 are disposed corresponding to each of the slide plate device holding elements 30. In the present embodiment, the thermal cycler device includes, for example, six slide plate device holding elements 30, six slide plate devices 40, and six heating blocks 50, and each of the slide plate device holding elements 30 is, for example, arranged side by side along a circular conveying path at an angle of 60 degrees.

Referring to FIG. 1, FIG. 2 and FIG. 3, the annular conveying element 60 is operated in stages, such that the plurality of slide plate device holding elements 30 carry the plurality of slide plate devices 40 along a circular conveying path. Referring to FIG. 1, FIG. 2 and FIG. 4, when each of the slide plate device holding elements 30 is moved to the corresponding heating block 50, the annular conveying element 60 stops operating, and each of the pressing blocks 20 performs a pressing process, such that each of the slide plate devices 40 is brought into contact with a corresponding heating block 50 for heat transfer. Since the pressing block 20 of the pressing element 10 can provide a fixed pressing force, heat transfer can be performed without using a thermal medium such as oil, and the heat transfer between each of the slide plate devices 40 and the corresponding heating block 50 can be uniform, thereby improving the inconvenience of the operation of the conventional thermal cycler device which uses oil and so on as a thermal medium.

Referring to FIG. 1, FIG. 2, FIG. 3, FIG. 4, FIG. 5A and FIG. 5B, after each of the slide plate devices 40 has performed the heat transfer with the corresponding heating block 50 for a specific period of time (the specific period of time, for example, is a programmed time for carrying out the polymerase chain reaction), the plurality of pressing blocks 20 stop pressing. On this occasion, the plurality of elastic supporting elements 32 corresponding to each of the slide plate device holding elements 30 can be used to move the slide plate device holding element 30 away from the heating block 50, thereby stopping the heat transfer between the slide plate device 40 and the heating block 50. In the present embodiment, the elastic supporting elements 32 are, for example, springs, but the disclosure is not limited thereto, and other elastic elements capable of supporting the slide plate device holding element 30 away from the heating block 50 may be used. As such, the annular conveying element 60 resumes operation, such that each of the slide plate device holding elements 30 moves along the circular conveying path to the next respective corresponding heating block 50.

In this embodiment, since the thermal cycler device includes, for example, six slide plate device holding elements 30, six slide plate devices 40, and six heating blocks 50, each of the slide plate device holding elements 30, each of the slide plate devices 40 and each of the heating blocks 50 are, for example, arranged side by side along a circular conveying path at an angle of 60 degrees. Therefore, the annular conveying element 30 is stopped once every 60 degrees, for example. In more detail, the annular conveying element 60 is, for example, operated by 60 degrees to move the slide plate device holding element 30 along the circular conveying path from the position of the previous corresponding heating block to the position of the next corresponding heating block. Then, the annular conveying element 60 is stopped, and the pressing block 20 performs a pressing process. After the slide plate device 40 has performed the heat transfer with the corresponding heating block for a specific period of time, the pressing block 20 stops pressing, the slide plate device holding element 30 moves away from the heating block, and the annular conveying element 60 resumes operation.

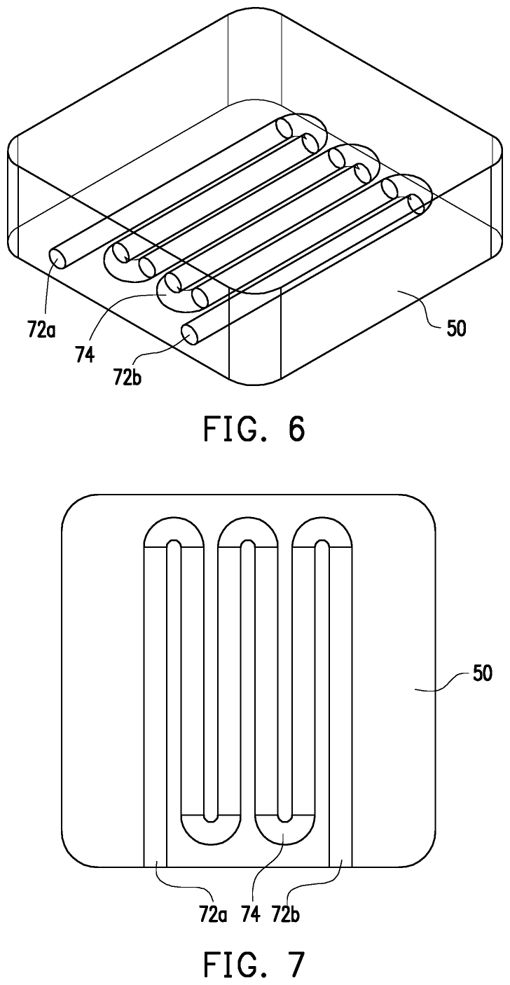

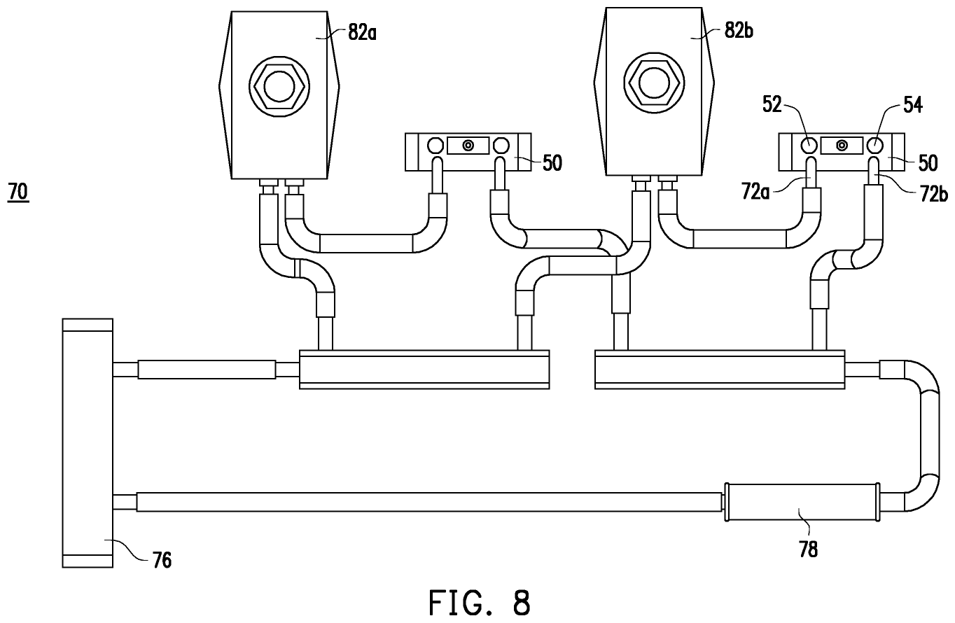

FIG. 6 is a schematic view of a water cooling device in a thermal cycler device according to an embodiment of the present disclosure. FIG. 7 is a top view of a water cooling device in a thermal cycler device according to an embodiment of the present disclosure. FIG. 8 is a complete schematic view of a water cooling device in a thermal cycler device according to an embodiment of the present disclosure.

Referring to FIG. 6, FIG. 7 and FIG. 8, the cooling device of the thermal cycler device of the present disclosure includes a water cooling device 70. The water cooling device 70 includes a water inlet 72a, a water outlet 72b and a waterway 74. The water cooling device 70 mainly uses the waterway 74 to enter the heating block 50 for cooling. In this embodiment, through the waterway 74 entering the heating block 50, the water cooling device 70 can cool the heating block from 95° C. to 60° C. in 18 seconds, thereby effectively and instantly adjusting the temperature of the heating block and increasing thermal history consistency. In addition, the cooling device of the thermal cycler device of the present disclosure further includes a fan device 80 (please refer to FIG. 2). After the water cooling device 70 cools the heating block 50 to a specific temperature (for example, 60° C.), the fan device 80 and heating bars 52 and 54 are utilized to maintain temperature. Referring to FIG. 8, the water cooling device 70 can operate collaboratively with a heat dissipation water tank 76, a pump 78, electromagnetic valves 82a and 82b and the heating blocks 50. In the present embodiment, the plurality of heating blocks are heated by using the heating bars 52 and 54, for example, the heating blocks can be heated to 95° C.

In summary, the present disclosure provides a thermal cycler device, which is different from the conventional thermal cycler device in that heat is exchanged between the heating block and the slide plate device by using a thermal medium such as oil. The present disclosure is designed by using the annular conveying element along with the pressing element to fix the pressing force, so as to achieve heat transfer uniformity and reinforce stability of experiment results under the condition where no thermal medium such as oil is used. As a result, the operational inconvenience of conventional thermal cycler device which uses oil and the like as thermal medium can be solved. In addition, the thermal cycler device of the present disclosure uses the waterway of the water cooling device to enter the heating block for quick cooling process, and the heating block can be cooled from 95° C. to 60° C. in 18 seconds, thereby enhancing thermal history consistency. In this way, it is possible to improve the adverse effect that the conventional thermal cycler device cannot regulate the temperature of the heating block efficiently and instantaneously, and therefore, the problem of inconsistent thermal history can be effectively avoided.

Although the disclosure has been disclosed by the above embodiments, the embodiments are not intended to limit the disclosure. It will be apparent to those skilled in the art that various modifications and variations can be made to the structure of the disclosure without departing from the scope or spirit of the disclosure. Therefore, the protecting range of the disclosure falls in the appended claims.

What is claimed is:

1. A thermal cycler device, comprising:
an annular conveying element, having a closed circular conveying path;
a plurality of slide plate device holding elements, disposed on the annular conveying element for holding a plurality of slide plate devices, and each of the slide plate device holding elements are arranged side by side along the circular conveying path at the same angle;
a plurality of heating blocks, disposed under the annular conveying element;
a pressing element, disposed above the plurality of slide plate device holding elements, having a plurality of pressing blocks, each of the pressing blocks respectively corresponding to each of the heating blocks; and
a cooling device, cooling the plurality of the heating blocks,
wherein the annular conveying element is operated in stages, such that the plurality of the slide plate device holding elements carry the plurality of slide plate devices to move along the circular conveying path, when each of the slide plate device holding elements moves to the respective corresponding heating block, the annular conveying element stops operating, and each of the pressing blocks performs a pressing process to make each of the slide plate devices to be in contact with the corresponding heating block for heat transfer.

2. The thermal cycler device according to claim 1, wherein each of the slide plate device holding elements is arranged side by side along the circular conveying path at an angle of 60 degrees.

3. The thermal cycler device according to claim 1, wherein the cooling device comprises a water cooling device using a waterway to enter the heating block for cooling.

4. The thermal cycler device according to claim 3, wherein the water cooling device cools the heating block from 95° C. to 60° C. in 18 seconds.

5. The thermal cycler device according to claim 3, wherein the cooling device further comprises a fan device, and when the water cooling device cools the heating block to a specific temperature, the fan device and heating bars are utilized to maintain the specific temperature.

6. The thermal cycler device according to claim 5, wherein after the heating block is cooled to 60° C., the specific temperature is maintained by using the fan device and the heating bars.

7. The thermal cycler device according to claim 1, further comprising a plurality of elastic supporting elements corresponding to each of the slide plate device holding elements, after each of the slide plate devices and the corresponding heating block have performed heat transfer for a specific period of time, the plurality of pressing blocks stop pressing, and each of the elastic supporting elements makes each of the slide plate device holding elements to move away from the heating block, so as to stop the heat transfer between the slide plate device and the heating block, and the annular conveying element resumes operation such that each of the slide plate device holding elements moves along the circular conveying path to the next respective corresponding heating block.

8. The thermal cycler device according to claim 7, wherein the annular conveying element stops operating at every fixed angle.

9. The thermal cycler device according to claim 1, further comprising heating bars for heating the plurality of heating blocks.

10. The thermal cycler device according to claim 9, wherein the heating bars heats the heating block to 95° C.

11. A thermal cycler device, comprising:
a plurality of heating blocks, for performing heat transfer to slide plate devices; and
a water cooling device, using a waterway to enter the heating block to perform cooling.
